(19) United States
(12) Patent Application Publication
(10) Pub. No.: US 2014/0220894 A1
(43) Pub. Date: Aug. 7, 2014

(54) METHOD OF SWITCHING PAIRING BETWEEN BLUETOOTH DEVICES

(71) Applicants: Chih-Wei Chen, Taipei City (TW); Sheng-Hung Wang, New Taipei City (TW)

(72) Inventors: Chih-Wei Chen, Taipei City (TW); Sheng-Hung Wang, New Taipei City (TW)

(21) Appl. No.: 14/162,601

(22) Filed: Jan. 23, 2014

(30) Foreign Application Priority Data
Feb. 1, 2013 (TW) 102104057

(51) Int. Cl. H04W 76/02; H04W 8/00

(52) U.S. Cl. CPC H04W 76/023; H04W 8/005
USPC 455/41.2

(57) ABSTRACT

A method of switching pairing between Bluetooth devices is disclosed. In one embodiment, the method is adapted to a Bluetooth server and two Bluetooth clients. The method enables the first Bluetooth client to interchange its pairing information with the Bluetooth server and the second Bluetooth client. Therefore, the Bluetooth server could use the interchanged pairing information to quickly connect with the second Bluetooth client.

### FIELD OF THE INVENTION

The present invention relates to a method of switching pairing between Bluetooth devices, and more particularly to a method of switching pairing between two Bluetooth clients and one Bluetooth server.

### BACKGROUND OF THE INVENTION

With the rapid development of technology, many electronic devices started to use wireless transmission to transmit or exchange data, and the most commonly used wireless transmission protocols are Bluetooth and IEEE 802.11 series.

The Bluetooth devices have to be paired before being used and the pairing process is rather complicated. In addition to some default settings, passwords are required during the pairing process. It would be very difficult for a lay person to pair the Bluetooth devices without reading a manual or having someone familiar with the pairing process to help. Even for a user who has paired the Bluetooth devices, when the user tries to pair a new headset or cell phone, it is difficult to recall all the steps after a long period of time, let alone the passwords is missing or forgotten.

Also, when a Bluetooth server has paired with a first Bluetooth client and the first Bluetooth client needs to be replaced by a second Bluetooth client, the Bluetooth server has to be reset and then pairs again with the second Bluetooth client. If the Bluetooth server needs to pair with the first Bluetooth client again, similar pairing process has to be repeated, which is very inconvenient.

### SUMMARY OF THE INVENTION

To overcome the problems stated above, the present invention provides a method of switching pairing between Bluetooth devices, and more particularly to a method of quickly switching pairing between multiple Bluetooth devices.

In one embodiment, the method of switching pairing between Bluetooth devices may include steps of a first Bluetooth client transmitting a server identification code to a second Bluetooth client; said first Bluetooth client receiving a second client identification code from the second Bluetooth client; said first Bluetooth client transmitting said second client identification code to a Bluetooth server; said second Bluetooth client writing said server identification code into a second client pairing information of the second Bluetooth client; said Bluetooth server writing said second client identification code to a serve pairing information of the Bluetooth server; disconnecting connection between the first Bluetooth client and the Bluetooth server; and connecting the second Bluetooth client with the Bluetooth server.

According to the embodiment described above, the method of switching pairing of Bluetooth devices in the present invention enables multiple Bluetooth clients to easily exchange pairing information to establish the connection with the same Bluetooth server without using a complicated and manual pairing process.

### BRIEF DESCRIPTION OF THE DRAWINGS

FIG. 1 illustrates is a schematic view of a system of switching pairing between Bluetooth devices in the present invention.

FIG. 2 illustrates a flow diagram of a method of switching pairing between Bluetooth devices in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

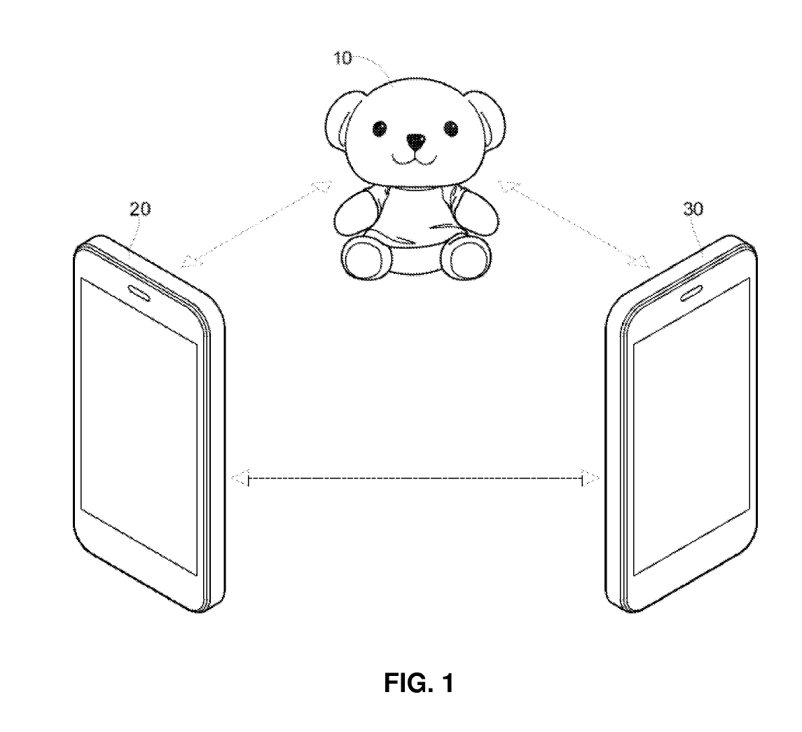

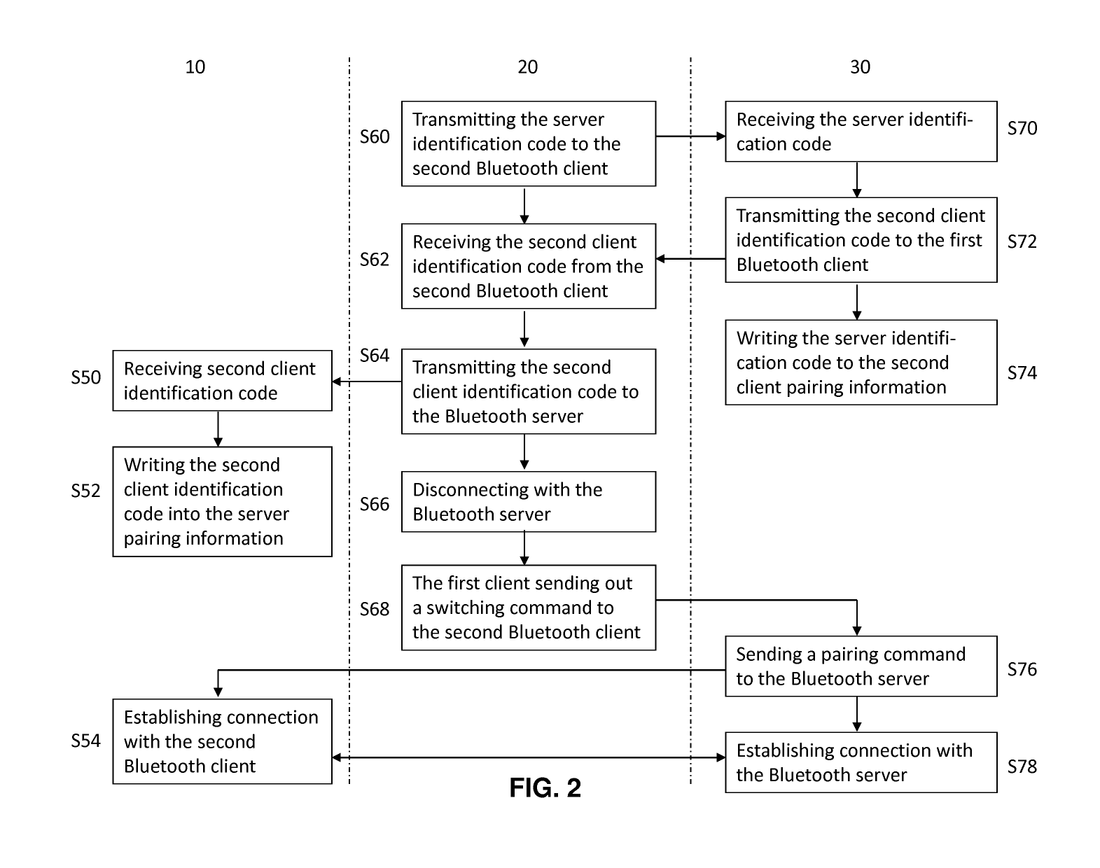

Referring to FIGS. 1 and 2, FIG. 1 is a schematic view of a system of switching pairing between Bluetooth devices in the present invention, and FIG. 2 shows a flow diagram of a method of switching pairing between Bluetooth devices in the present invention.

FIGS. 1 and 2 illustrate the applications of, but not limited to three Bluetooth devices 10, 20 and 30. In one embodiment, these three Bluetooth devices are Bluetooth server 10, a first Bluetooth client 20 and a second Bluetooth client 30.

The Bluetooth server 10 can be, but not limited to, a headset or the like. In another embodiment, the Bluetooth server 10 can be connection devices or Bluetooth peripheral devices. In some literature, the Bluetooth server 10 is referred to a servant device. When in use, the Bluetooth server 10 can also be any Bluetooth devices connecting to the Bluetooth server. The first Bluetooth client 20 and the second Bluetooth client 30 can be referred to Bluetooth control devices or connection devices, and some literature refers the Bluetooth client to a host device. In a further embodiment, the first Bluetooth client 20 and second Bluetooth client 30 can be a device on the user's end, such as a cell phone, computer, tablet, personal digital assistant (PDA), etc. In the present invention, the Bluetooth client is a Bluetooth child locator. More specifically, the child can take the Bluetooth server 10, while the first Bluetooth client 20 and second Bluetooth client 30 can be the parents' cell phone or tablet. When in use, assuming that the father is the first Bluetooth client 20 paired with the Bluetooth server 10 to monitor the child in a predetermined safety range, and if the father has to leave the child beyond the distance of effective Bluetooth connection, he can switch the Bluetooth pairing information to the mother who is the second Bluetooth client 30, so the Bluetooth server 10 and the second Bluetooth client 30 are still connected and the mother can keep monitoring her child within the safety range.

In still another embodiment, the method of switching Bluetooth device pairing can be a software (not limited to Application software, or Apps) between the Bluetooth server 10, the first Bluetooth client 20 and the second Bluetooth client 30. The method of switching pairing between Bluetooth devices can be partially done by manual operation and partially done by the hardware in the Bluetooth client devices. An “App” is used in the following embodiment, but the present invention is not limited thereto.

The Bluetooth server 10 has a server identification code (SIC), the first Bluetooth client 20 has a first client identification code (FCIC), and the second Bluetooth client 30 has a second client identification code (SCIC). The SIC, FCIC and SCIC can be the only universal unique identifier (UUID) of the Bluetooth devices respectfully. A Bluetooth device uses the UUID to identify the other Bluetooth device that is pairing with itself. Each of the Bluetooth server 10, the first Bluetooth client 20 and the second Bluetooth client 30 has an information storing area used to store the UUID after the Bluetooth device is paired with the other. The information saved in the information storing area is called “pairing information.” In the present invention, the pairing information of the Bluetooth server 10, the first Bluetooth client 20 and the second Bluetooth client 30 is referred to server pairing information, first client pairing information and second client pairing information, respectfully. In other words, if the Bluetooth server 10 has paired with the first Bluetooth client 20, the UUID of the first Bluetooth client 20 will be written in the server pairing information, and the UUID of the Bluetooth server 10 will be written in the first client pairing information. Likewise, if the Bluetooth server 10 has paired with the second Bluetooth client 30, the UUID of the second Bluetooth client 30 will be written in the server pairing information, and the UUID of the Bluetooth server 10 will be written in the second client pairing information.

Referring to FIG. 2, the method of switching pairing Bluetooth devices may include steps of: S60: a first Bluetooth client 20 transmitting a server identification code of the Bluetooth server 10 to a second Bluetooth client 30, wherein the server identification code is corresponding to the Bluetooth server 10, and first client pairing information is corresponding to the first Bluetooth client 20; S62: the first Bluetooth client 20 receiving a second client identification code from the second Bluetooth client 30, and the second client identification code is corresponding to the second Bluetooth client 30; S74: the second Bluetooth client 30 writing said server identification code into second client pairing information; S64: the first Bluetooth client 20 transmitting the second client identification code to the Bluetooth server 10; S52: the Bluetooth server 10 writing said second client identification code into server pairing information; S66: disconnecting the first Bluetooth client 20 and the Bluetooth server 10; S68: the first Bluetooth client 20 sending out a switching command to the second Bluetooth client 30; and S78 and S54: connecting the Bluetooth server 10 and the second Bluetooth client 30.

Before step S60, the Bluetooth server 10 and the first Bluetooth client 20 are paired. In other words, the Bluetooth server 10 has the server pairing information and the first Bluetooth client 20 has the first client pairing information. The server pairing information at least includes the first client identification code of the first Bluetooth client 20. As stated above, the Bluetooth server 10 uses the first client identification code to identify the Bluetooth device that is paired with itself. The first client identification code can be, but not limited to, UUID or Media Access Control address (MAC address). Similarly, the first pairing information at least includes the server identification code of the Bluetooth server 10, and the server identification code is used for the first Bluetooth client 20 to indentify the paired Bluetooth device. The server identification code can be UUID or MAC address.

In step S60, the first Bluetooth client 20 transmits the server identification code in the first client pairing information to the second Bluetooth client 30, while the second Bluetooth client 30 receives the server identification code as illustrated in step S70, wherein the transmission between the first Bluetooth client 20 and second Bluetooth client 30 can be either by Universal Serial Bus, RS232, RS485, or wireless transmission such as Bluetooth, 3G, WiFi.

After step S60, the first Bluetooth client 20 can receive the second client identification code from the second Bluetooth client 30 as shown in step S62. In other words, the second Bluetooth client 30 can proceed to step S72 to transmit the second client identification code to the first Bluetooth client 20, wherein the second client identification code is not limited to the UUID of the second Bluetooth client 30, or MAC address.

After step S70, the second Bluetooth client 30 can write the server identification code into the second client pairing information of the second Bluetooth client 30, either before step S72 or at step S74.

The first Bluetooth client 20 can then transmit the second client identification code to the Bluetooth server 10 (S64) and the Bluetooth server 10 receives the second client identification code in step S50, and saves the second client identification code to the server pairing information of the Bluetooth server 10 in step S52.

Steps S60 and S64 can be referred to a command of writing in the identification code, meaning that when the first Bluetooth client 20 sends the command of writing the server identification code into the second Bluetooth client 30, the second Bluetooth client 30 can proceed to receive the server identification code (step S70) and write (step S74) the server identification code into the second client pairing information. Likewise, when the first Bluetooth client 20 sends the command of writing the second client identification code to the Bluetooth server 10, the Bluetooth server 10 can proceed to receive the second client identification code (step S50) and write (step S52) the second client identification code into the server pairing information. The purpose of this command is to modify the Bluetooth pairing information with currently received identification code in the Bluetooth device that receives the command.

In another embodiment, step S62 can be processed before step S60. In other words, the first Bluetooth client 20 can process step 62 to receive the second client identification code, and then process step S60 to transmit the server identification code to the second Bluetooth client 30.

The first Bluetooth client device 20 can then proceed to step S66 to disconnect with the Bluetooth server 10, or proceed to step S68 to send out a switching command to the second Bluetooth client 30, wherein the order of steps S66 and S68 can be switched, and the switching command is sent out from the first Bluetooth client 20 to the second Bluetooth client 30 to enable the second Bluetooth client 30 to send out a pairing command to the Bluetooth server 10.

When the second Bluetooth client 30 sends out the pairing command to the Bluetooth server 10, the Bluetooth server 10 can be connected to the second Bluetooth client 30 (S54, S78) because the Bluetooth server 10 has been disconnected with the first Bluetooth client 20 and the server pairing information of the Bluetooth server 10 has the second client identification code of the second Bluetooth client 30, wherein step S66 is disconnecting the connection between the Bluetooth server 10 and the first Bluetooth client 20, and steps S54 and S78 are establishing the connection between the Bluetooth server 10 and the second Bluetooth client 30.

In still another embodiment, steps S66 and S68 can be omitted, meaning that the Bluetooth client 10 and the second Bluetooth client 30 can be connected by themselves. More specifically, when the Bluetooth server 10 writes the second client identification code into the server pairing information, the Bluetooth client 10 can be automatically disconnected with the first Bluetooth client 20, meaning automatically switching to an “Advertising Mode” and waiting for pairing with the second Bluetooth client 30. Meanwhile, when the second Bluetooth client 30 receives and writes in the server identification code, the second Bluetooth client 30 can send out the pairing command to the Bluetooth server 10 automatically. Thus, when the Bluetooth server 10 receives the pairing command from the second Bluetooth client 30, the Bluetooth server 10 is configured to accept that command to switch to a ‘Connected Mode.”

When the Bluetooth server 10 switches to the “Advertising Mode” and the server pairing information has been changed to the second client identification code, even though the first Bluetooth client 20 sends out the pairing command to the Bluetooth server 10, the connection between the Bluetooth server 10 and the first Bluetooth client 20 will not be established because the server pairing information is now containing the second client identification code, not the first client identification code.

Thus, in this embodiment, the first Bluetooth client 20 only processes steps S60, S62 and S64; the second Bluetooth client 30 processes steps S70, S72, S74, S76 and S78, and the Bluetooth server 10 processes steps S50, S52 and S54, so steps S66 and S68 are omitted.

The pairing switching method described above uses the first Bluetooth client 20 as a main controlling device. In a further embodiment, the second Bluetooth client 30 can also be used as the main controlling device, which can be illustrated as following:

The second Bluetooth client 30 sends out a switching pairing command to the first Bluetooth client 20, and meanwhile the second Bluetooth client 30 would proceed to step S72 to transmit the second client identification code to the first Bluetooth client 20, and the first Bluetooth client 20 can also proceed to step S60 to transmit the server identification code to the second Bluetooth client 30. The second Bluetooth client 30 can then save the server identification code to the second client pairing information and continue to send out the pairing command to the Bluetooth server 10.

When the first Bluetooth client 20 receives the second client identification code, it sends out a command to the Bluetooth server 10 to write in the second client identification code, and the Bluetooth server 10 writes the second client identification code into the server pairing information after receiving such command from the first Bluetooth client 20. The Bluetooth server 10 is then switched to the Adverting Mode to wait for the pairing command from the second Bluetooth client 30. Once the Bluetooth server 10 receives the pairing command from the second Bluetooth client 30, it accepts the pairing command to establish the connection with the second Bluetooth client 30.

According to the embodiments described above, the method of switching pairing of Bluetooth devices in the present invention enables multiple Bluetooth clients to easily exchange pairing information to establish the connection with the same Bluetooth server without using a complicated and manual pairing process.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A method of switching pairing between Bluetooth devices comprising steps of:
a first Bluetooth client transmitting a server identification code to a second Bluetooth client, said server identification corresponding to a Bluetooth server;
said first Bluetooth client receiving a second client identification code, said second client identification code corresponding to the second Bluetooth client;
said first Bluetooth client transmitting said second client identification code to the Bluetooth server;
said second Bluetooth client writing said server identification code into a second client pairing information of the second Bluetooth client;
said Bluetooth server writing said second client identification code to a serve pairing information of the Bluetooth server; and
establishing connection between the second Bluetooth client and the Bluetooth server.

2. The method of switching pairing between Bluetooth devices of claim 1, wherein the step of establishing connection between the second Bluetooth client and the Bluetooth server includes steps of:
said second Bluetooth client send out a pairing command to the Bluetooth serve; and
said Bluetooth server receiving the pairing command and connecting with the second Bluetooth client.

3. The method of switching pairing between Bluetooth devices of claim 1, further comprising a step of said first Bluetooth client sending out a switching command to a second Bluetooth client before the connection between the second Bluetooth client and the Bluetooth server.

4. The method of switching pairing between Bluetooth devices of claim 3, further comprising a step of disconnecting connection between the first Bluetooth client and the Bluetooth server.

5. A method of exchanging pairing information between Bluetooth devices comprising steps of:
a first Bluetooth client sending out a command to a second Bluetooth client to write in a server identification code, said server identification code corresponding to a Bluetooth server;
said first Bluetooth client receiving a second client identification code, said second client identification code corresponding to the second Bluetooth client; and
said first Bluetooth client sending out a command to the Bluetooth server to write in the second client identification code.

6. The method of exchanging pairing information between Bluetooth devices of claim 5, further comprising a step of said first Bluetooth client sending out a switching command to the second Bluetooth client after the step of said first Bluetooth client sending out a command to the Bluetooth server to write in the second client identification code.

7. The method of exchanging pairing information between Bluetooth devices of claim 5, further comprising a step of disconnecting connection between the first Bluetooth client and the Bluetooth server after the step of said first Bluetooth client sending out a command to the Bluetooth server to write in the second client identification code.

8. A method of exchanging pairing information between Bluetooth devices comprising steps of:
a second Bluetooth client receiving a command to write in a server identification code, said server identification code corresponding to a Bluetooth server;
said second Bluetooth client writing the server identification code into a second client pairing information thereof;
said second Bluetooth client transmitting a second client identification code to a first Bluetooth client, said second client identification code corresponding to the second Bluetooth client;
said second Bluetooth client sending out a pairing command, and
said second Bluetooth client connecting with the Bluetooth client.

9. A method of exchanging pairing information between Bluetooth devices comprising steps of:
a Bluetooth server receiving a command to write in a second client identification code; said second client identification code corresponding to the second Bluetooth client;
said Bluetooth server writing the second client identification code into a server pairing information thereof;
said Bluetooth server connecting with the second Bluetooth client.

10. The method of exchanging pairing information between Bluetooth devices of claim 9, further comprising a step of said Bluetooth server switching to an “Advertising Mode” before connecting with the second Bluetooth client.
